(19) United States
(12) Patent Application Publication
(10) Pub. No.: US 2020/0315749 A1
(43) Pub. Date: Oct. 8, 2020

(54) DENTAL IMPLANTS

(71) Applicant: DENFLEX CO., LTD, Seoul (KR)

(72) Inventor: Hyung Woo KIM, Goyang (KR)

(21) Appl. No.: 16/302,037

(22) PCT Filed: Jan. 15, 2018
(86) PCT No.: PCT/KR2018/000694

§ 371 Date: Nov. 15, 2018

(30) Foreign Application Priority Data
Jan. 13, 2017 (KR) 10-2017-0006425

(51) Int. Cl. A61C 8/00

(52) U.S. Cl. CPC A61C 8/0074; A61C 8/0086; A61C 8/0056; A61C 8/0057

(57) ABSTRACT

The present invention provides a dental implant comprising: a first coupling part 150 is provided on an inner surface of the axial hole of the fixture, the first coupling part comprising a coupling recess depressed outward, in a predetermined location on the inner surface of the axial hole, and a first corresponding coupling part provided on an outer circumferential surface of the coupling leg 122 to be complementarily coupled to the first coupling part 150, the first corresponding coupling part comprising a coupling protrusion, wherein, in a state in which the abutment is fitted into the fixture by complementary coupling between the first coupling part and the first corresponding coupling part; when a rotation force applied to the abutment has less than a predetermined level, the abutment is prevented from rotating relative to the fixture in a circumferential direction, and when the rotation force applied to the abutment is equal to or greater than the predetermined level, the coupling leg of the abutment is elastically bendable radially inwardly toward a central axis and the abutment is rotated in the circumferential direction, allowing the coupling protrusion of the first corresponding coupling part to be released from the coupling recess of the first coupling part, so that the fixture and the abutment are decoupled from each other.

### CROSS REFERENCE TO RELATED APPLICATIONS

This application is a 371 application for international patent application PCT/KR2018/000694 having the same title and is related to and claims priority from Korea Patent Application 10-2017-0006425 filed Jan. 13, 2017 which is incorporated herein by reference in its entirety.

### TECHNICAL FIELD

The present invention relates to a dental implant implanted in the alveolar bone to form an artificial tooth. More particularly, the present invention relates to a dental implant whereby an abutment is easily separated from a fixture of the dental implant, and vertical occlusal force applied thereto may be efficiently absorbed by improving a coupling structure between the fixture and the abutment.

### BACKGROUND ART

In dentistry, an implant means an artificial tooth substituting for a lost natural tooth or a dental procedure that is conducted in such a manner that a fixture is implanted into a jawbone to be fused with the jawbone for a predetermined period, and prostheses such as a coupling member, artificial teeth, and the like are then fixed thereon so that the original functions of teeth can be recovered. Although a typical prosthetic appliance or a typical false tooth damages surrounding teeth or bones according to the elapse of the time, an implanted tooth does not damage a surrounding tooth structure, and performs the function of an original tooth in the same shape as that of the original tooth. In addition, the implanted tooth is not decayed, so that the implanted tooth can be used for a long time. Also, implants may facilitate the recovery of a single missing tooth and improve the function of an artificial tooth for a partially or completely edentulous patient, and may improve dental prosthesis recovery in terms of aesthetics. Furthermore, implants disperse an excessive stress applied on tissues of a support bone there around, and contribute to stabilization of teeth in a row.

In the case of such an implant, a fixture implanted into a jawbone is coupled with a coupling part of an abutment with an upper axial hole of the fixture, and prosthesis is fixed on an upper part of the abutment.

In a conventional implant structure, a fixture and an abutment are thread-coupled, or a coupling recess of the fixture and a coupling protrusion of the abutment are elastically and complementarily coupled. In a conventional thread-coupled structure, when a continuous load is repeatedly generated within the mouth as an implant wearer chews food, the screw coupling state becomes loose by being rotated since the screw slightly vibrates, and the oscillation width is gradually increased. Accordingly, a gap between the fixture and the abutment is generated. In other words, the artificial tooth shakes, thus the implant user may not easily chew the food, and undesirable mastication pressure may occur around the artificial tooth.

In addition, in the conventional implant structure, as described above, when coupling the abutment with the fixture, a thread-coupling may be performed while an accurate coupling position is not found.

Accordingly, the artificial tooth and the alveolar bone may be damaged.

In addition, an implant unit having the above conventional implant structure has many difficulties in coupling the screw within a narrow oral cavity. Particularly, in the case of a patient whose surgical area is located on the back teeth side or who cannot widen his or her mouth widely, the implant procedure becomes more difficult.

As a conventional technique for solving such conventional problems, a dental implant of Korean Patent No. 10-0668368 has been proposed.

In the conventional technique, a dental implant includes: a fixture having an axial hole in an upper portion thereof and implanted into a jawbone; and an abutment having coupling legs made of a shape memory alloy, the legs being inserted into the axial hole of the fixture in a lower portion thereof and elastically coupled with the fixture so that teeth can be used to chew food.

Elastic coupling structures between the fixture and the abutment of the conventional technique have realized much technical advancement by effectively improving the thread-coupling problems. In addition, in actual use, it is very convenient to use since the coupling protrusion of the coupling leg is automatically and elastically coupled with the coupling recess of the fixture when the abutment is inserted within the fixture.

However, the above elastic coupling structures between the fixture and the abutment of the conventional technique cause inconvenience when separating the abutment from the fixture, and are not able to effectively perform buffer functions when vertical occlusal force is applied.

In other words, in order to separate the abutment from the fixture, the abutment is upwardly pulled with respect to the fixture by force such that the coupling protrusion or the coupling recess formed in the coupling leg is detached from the coupling recess or the coupling protrusion that is formed in the axial hole inner surface of the fixture in association by being upwardly pulled.

However, upwardly pulling the abutment with respect to the fixture by force as described above may apply large force to the alveolar bone of the patient through the fixture. As a result, there is great risk of damaging the alveolar bone of the patient due to excessive force. In addition, the corresponding coupling part and the coupling part which are configured with the coupling protrusion and the coupling recess formed in the abutment and the axial hole inner surface of the fixture become worn down due to repeated attachments and detachments, thus coupling force is reduced. Further, when the upper surface of the fixture is deeply implanted in a gum, an extraction device disclosed in Korean Patent No. 10-1309417 must be used to separate thee abutment from the fixture without damaging the fixture, the abutment and the alveolar bone. However, when the fixture is deeply implanted from the top of the alveolar bone, the extraction device may not be used or applied.

In addition, in the conventional technique described above, the operator may require a large force to upwardly pull the abutment with respect to the fixture y force, and such a procedure may act as a considerable mental burden on the implant procedure.

In addition, in the conventional technique described above, the implant structure may perform a buffer function for horizontal pressure, but a buffer function for vertical occlusion pressure may not be performed. Accordingly, there is a need for a structure that effectively performs a buffer function for vertical occlusion pressure.

### DISCLOSURE

### Technical Problem

Accordingly, the present invention has been made keeping in mind the above problems occurring in the prior art, and an object of the present invention is to provide an improved dental implant in which an corresponding coupling part formed in a lower part of an abutment and a coupling part formed in an axial hole inner surface of a fixture in association with the corresponding coupling part are separated from each other with less force when separating the abutment from the fixture. In addition, although the abutment is rotated with excessive force, the fixture and the abutment are not re-coupled by being rotated again at a predetermined angle. Further, coupling force for performing a function of preventing a vertical directional separation in case of repeated attachments and detachments is not reduced, and the abutment is easily separated from the fixture by upwardly pulling the abutment with less force.

In addition, another object of the present invention is to provide an improved dental implant in which an operator may easily detect a separation state between the abutment and the fixture since the abutment is separated by being automatically and upwardly pushed from the fixture by rotating the abutment. Accordingly, the operator may procedure an implant procedure without difficulty and burdens.

Another object of the present invention is to provide a dental implant in which a linear or spiral slit is provided in a portion between the top portion and the bottom portion of the abutment coupled to the fixture, such that the abutment has a function of absorbing a significant amount of external force, including chewing pressure, applied to the implant. It is therefore possible to distribute stress applied to the abutment across entire portions thereof and prevent stress from being concentrated in a specific portion of the abutment. It is also possible to significantly improve the sensation of chewing and endurance of the implanted tooth.

In addition, another object of the present invention is to provide an improved dental implant in which a rotation with respect to rotation force less than a predetermined value within the axial hole of the fixture is prevented without adding an additional rotation prevention form in the coupling axial part of the abutment. Further, another object of the present invention is to provide an improved dental implant in which attachments and detachments between the fixture and the abutment are easily performed even though the fixture is deeply implanted from an upper part of an alveolar bone.

In addition, another object of the present invention is to provide an improved dental implant in which vertical occlusal force is effectively absorbed.

Hereinafter, for convenience of description, a function of preventing the abutment being rotated with respect to the fixture for rotation force equal to or less than a predetermined value is defined as “rotation prevention function”, and a function of preventing the abutment being separated from the fixture in a vertical direction is defined as “vertical separation prevention function”.

### Technical Solution

In order to accomplish the above object, one embodiment of the present invention provides a dental implant comprising: a fixture implanted in an alveolar bone to provide an artificial tooth root; an abutment coupled with a prosthesis at an upper part thereof, and provided at a lower par thereof with a coupling leg elastically coupled with an axial hole of the fixture by being elastically bent radially inwardly toward a central axis and restoring an original shape thereof; a first coupling part 150 provided on an inner surface of the axial hole of the fixture, the first coupling part comprising a coupling recess depressed outward, in a predetermined location on the inner surface of the axial hole; and a first corresponding coupling part provided on an outer circumferential surface of the coupling leg 122 to be complementarily coupled to the first coupling part 150, the first corresponding coupling part comprising a coupling protrusion, wherein the first coupling part comprises at least one first coupling part provided in a circumferential direction of the inner surface of the axial hole of the fixture so as not to provide an annular shape along the entire circumference, such that the abutment is coupled to the fixture at a predetermined angle when the abutment is pushed into the fixture, and wherein, in a state in which the abutment is fitted into the fixture by complementary coupling between the first coupling part and the first corresponding coupling part; when a rotation force applied to the abutment has less than a predetermined level, the abutment is prevented from rotating relative to the fixture in a circumferential direction, and when the rotation force applied to the abutment is equal to or greater than the predetermined level, the coupling leg of the abutment is elastically bendable radially inwardly toward a central axis and the abutment is rotated in the circumferential direction, allowing the coupling protrusion of the first corresponding coupling part to be released from the coupling recess of the first coupling part, so that the fixture and the abutment are decoupled from each other.

In addition, another embodiment of the present invention provides a dental implant comprising: a fixture implanted in an alveolar bone to provide an artificial tooth root; an abutment coupled with a prosthesis at an upper part thereof, and provided at a lower par thereof with a coupling leg elastically coupled with an axial hole of the fixture by being elastically bent radially inwardly toward a central axis and restoring an original shape thereof; a first coupling part 150 provided on an inner surface of the axial hole of the fixture, the first coupling part comprising a coupling recess depressed outward, in a predetermined location on the inner surface of the axial hole; and a first corresponding coupling part provided on an outer circumferential surface of the coupling leg 122 to be complementarily coupled to the first coupling part 150, the first corresponding coupling part comprising a coupling protrusion; wherein the first coupling part comprises at least one first coupling part provided in a circumferential direction of the inner surface of the axial hole of the fixture so as not to provide an annular shape along the entire circumference, such that the abutment is coupled to the fixture at a predetermined angle when the abutment is pushed into the fixture and the first corresponding coupling part of the abutment is releasable from the first coupling part when the rotation force applied to the abutment is equal to or greater than a predetermined level and then the abutment is rotated in the circumferential direction, wherein a second corresponding coupling part is provided on an outer circumferential surface of the coupling leg provided on the lower part of the abutment, the second corresponding coupling part comprising a fitting protrusion protruding from the outer circumferential surface of the coupling leg in an outer diameter direction to prevent the abutment from being vertically decoupled from the fixture, and a second coupling part is provided on the inner surface of the axial hole of the fixture, the second coupling part comprising a stepped portion extending outward to be coupled to the second corresponding coupling part in a corresponding manner, and wherein, when the first coupling part and the first corresponding coupling part are coupled to each other, the second corresponding coupling part and the second coupling part are coupled to each other to enhance axial coupling force between the abutment and the fixture, and when the first corresponding coupling part is released from the first coupling part by rotation of the abutment in the circumferential direction, the second corresponding coupling part is automatically released from the second coupling part by the coupling leg of the abutment elastically bent inwardly, so that the fixture and the abutment are decoupled from each other.

### Advantageous Effects

According to the present invention, the present invention includes a first corresponding coupling part that mainly performs a rotation prevention function formed in a lower part of an abutment, and a first coupling part formed in an axial hole inner surface of a fixture at a position that is in association with the first corresponding coupling part so that the first coupling part is complementarily coupled with the first corresponding coupling part.

Accordingly, according to the present invention, in the process of separating the abutment from the fixture, the abutment and the fixture are easily separated by pulling lightly upwardly the abutment from the fixture since the first corresponding coupling part is separated from the first coupling part when the abutment is rotated with respect to the fixture.

In addition, according to the present invention, an inclined surface may be provided on the inner surface of the axial hole of the fixture except for a region of the inner surface in which the first coupling part is provided, such that an inner diameter of the inclined surface continuously decreases in a bottom direction. When a coupling protrusion of the first corresponding coupling part is released from the coupling recess of the first coupling part by rotation of the abutment in the circumferential direction, the coupling protrusion of the first corresponding coupling part pushes the abutment upwards from the fixture due to elastic repulsion from the inclined surface of the inner surface of the axial hole of the fixture, thereby automatically decoupling the abutment and the fixture from each other.

In addition, in the present invention, the abutment is not re-coupled with the fixture under excessive rotation since the abutment is automatically and upwardly pushed when the abutment is rotated with respect to the fixture.

In addition, according to the present invention, in the process of separating the abutment from the fixture, the abutment is automatically separated from the fixture by being upwardly protruded from the fixture when the abutment is rotated with respect to the fixture. Accordingly, the operator may easily detect a separation state between the abutment and the fixture. Thus, the implant procedure may easily and conveniently progress without difficulty and worry. In addition, according to the present invention, an additional polygonal form for a rotation prevention function is not provided to the abutment. In addition, according to the present invention, when vertical occlusal force is applied to the abutment, the inclined surface may effectively absorb vertical occlusal pressure.

In addition, according to the present invention, the linear or spiral slit is provided in a portion between the top portion and the bottom portion of the abutment coupled to the fixture, such that the abutment has a function of absorbing a significant amount of external force, including chewing pressure, applied to the implant. It is therefore possible to distribute stress applied to the abutment across entire portions thereof and prevent stress from being concentrated in a specific portion of the abutment. It is also possible to significantly improve the sensation of chewing and endurance of the implanted tooth.

### DESCRIPTION OF DRAWINGS

FIG. 1 is an external perspective view showing a coupling structure in which an abutment of a coupling leg type is coupled to a fixture in a dental implant according to the present invention.

FIG. 2 is a longitudinal sectional view showing a dental implant according to the present invention.

FIG. 3a is a sectional plan view of a first corresponding coupling part that performs a rotation prevention function in the dental implant according to the present invention, and is a sectional plan view of FIG. 2 along an A-A line.

FIG. 3b is a sectional plan view of a first coupling part that performs a rotation prevention function in the dental implant according to the present invention, and is a sectional plan view of FIG. 2 along a B-B line.

FIG. 4a is a longitudinal sectional view showing a coupling intermediate state between the abutment and the fixture in the dental implant according to the present invention.

FIG. 4b is a longitudinal sectional view showing a coupled state between the abutment and the fixture in the dental implant according to the present invention.

FIG. 5a is a sectional planar view showing an intermediate coupling process between the abutment and the fixture in the dental implant according to the present invention.

FIG. 5b is a sectional planar view showing a coupled state between the abutment and the fixture in the dental implant according to the present invention.

FIG. 6a is a longitudinal sectional view showing a decoupling intermediate process between the abutment and the fixture in the dental implant according to the present invention.

FIG. 6b is a longitudinal sectional view showing a state in which the abutment is automatically and upwardly pushed from the fixture since the first corresponding coupling part that mainly performs a rotation prevention function is lifted up by the inclined surface of the fixture in the dental implant according to the present invention.

FIG. 7 is a longitudinal sectional view showing a structure of a coupling recess downwardly extending from the top of the inner inclined surface of the axial of the fixture according to another embodiment of the present invention.

FIG. 9 is a sectional view showing the longitudinal section of the abutment shown in FIG. 8.

FIG. 10a and FIG. 10b are sectional views along C-C line in FIGS. 8 and 9. FIG. 10a shows a section before the abutment is completely coupled to the fixture and FIG. 10b a section after the abutment is completely coupled to the fixture.

FIG. 11 is a perspective view showing a structure in which a helical cutout is formed in the middle part of an abutment according to another embodiment of the present invention.

FIG. 12 is a sectional view showing the longitudinal section of the abutment shown in FIG. 11.

### MODE FOR INVENTION

Hereinafter, preferred embodiments of the present invention will be described in detail with reference to the accompanied drawings.

The dental implant 100 according to the present invention comprises a fixture 110 forming an artificial tooth root implanted in an alveolar bone (not shown), and an abutment 120 coupled with the fixture 110 at a low part thereof and coupled with a prosthesis (crown or denture) at an upper part thereof.

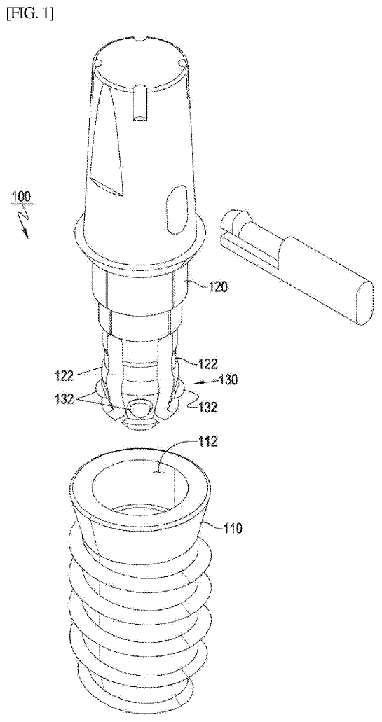

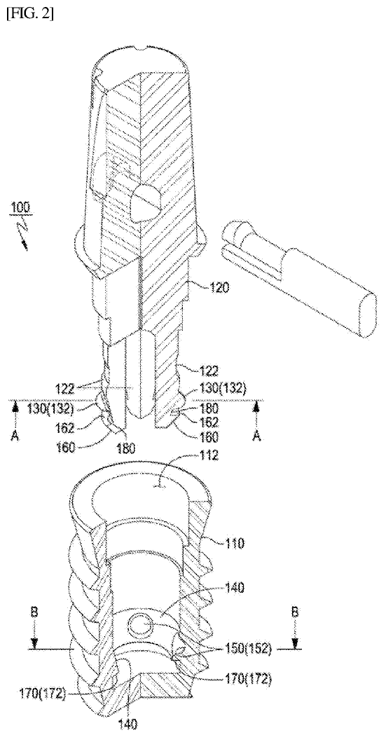

An implant procedure is performed by elastically and detachably coupling the fixture 110 and the abutment 120 as shown in FIG. 1 and FIG. 2.

The dental implant 100 according to the present invention is formed in at least one coupling leg 122 that is formed in a lower part of the abutment 120 and inserted into the fixture 110. The dental implant 100 includes at least one first corresponding coupling part 130 that mainly performs a rotation prevention function with respect to rotation force less than a predetermined value. The first corresponding coupling part 130 is formed with a circular coupling protrusion 132 in a lower outer surface of each coupling leg 122. In addition, the coupling protrusion may have a non-circular form. In other words, the coupling protrusion may have various forms in addition to the circular form. For example, the coupling protrusion may have a band-shaped protruding part by a predetermined distance along a circumferential direction.

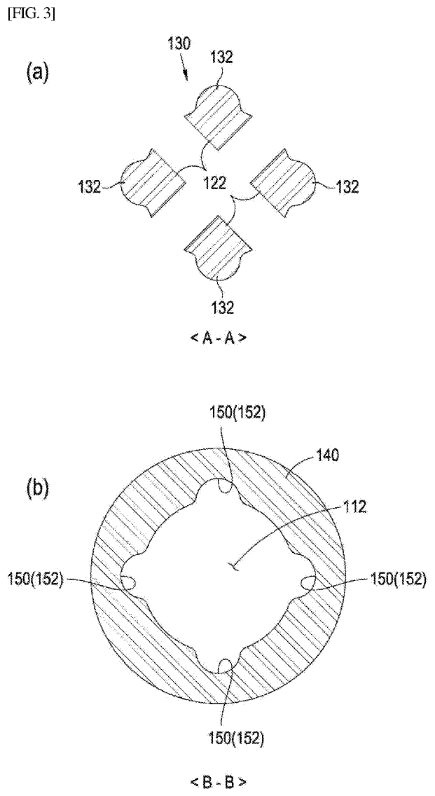

The first corresponding coupling part 130 that mainly performs a rotation prevention function with respect to the rotation force less than the predetermined value may be formed with, for example, a circular coupling protrusion 132 formed in each of four coupling legs 122 as shown in a sectional planar view of FIG. 3a, or may be formed in a part of the coupling legs (not shown). Although not specifically shown, it will be understood by those skilled in the art that the number of the coupling legs can vary in the various designs.

In addition, the dental implant 100 according to the present invention includes a first coupling part 150 that performs a rotation prevention function by being outwardly depressed on the inner surface 140 of the axial hole of the fixture and complementarily coupled with the first corresponding coupling part 130.

Preferably, the first coupling part 150 is configured such that at least one portion thereof is depressed outward when viewed from the cross-section taken perpendicularly with respect to the vertical central axis of the axial hole of the fixture.

Most preferably, at least one first coupling part 150 is provided in the circumferential direction of the inner surface of the axial hole 112 of the fixture 110 so as not to provide an annular shape along the entire circumference. Accordingly, the abutment is coupled to the fixture only at a predetermined angle when the abutment is pushed into the axial hole of the fixture. When the abutment is rotated in the circumferential direction by a predetermined level of torque or higher applied thereto, the first corresponding coupling part 130 of the abutment may be released from the first coupling part 150.

Herein, vertical lengths of the first corresponding coupling part and the first coupling part may be different. However, horizontal distances thereof in a circumferential direction should be identical within a numerical mechanical tolerance. Thereby, there will be no excessive micro-fluctuations for rotation force equal to or less than a predetermined value.

The first coupling part 150 may be formed with a circular coupling recess 152 that is complementarily coupled in association with the circular coupling protrusion 132 of the first corresponding coupling part 130 formed in the axial hole inner surface 140 of the fixture. Herein, a form of the coupling recess or the coupling protrusion may vary, and the shape of each first corresponding coupling part formed in each coupling leg may not be identical. Accordingly, the shape of a first coupling part complementarily coupling with the first corresponding coupling part may be different.

More particularly, the axial hole inner surface 140 of the fixture can be formed as an inclined surface on the inner surface of the axial hole 112 of the fixture 110 such that the inner diameter thereof decreases downward from a predetermined position. Specifically, since the inclined surface of the axial hole of the fixture has a conical structure, the inner diameter of which decreases downward from a predetermined position on the inner surface of the axial hole of the fixture. The inclined surface is provided on the inner surface of the axial hole of the fixture, on which the first coupling part is provided, except for a region of the inner surface in which the first coupling part is provided, such that an inner diameter of the inclined surface continuously decreases in a bottom direction.

In addition, in order to easily find a coupling position of the fixture and the abutment, the first coupling part may be formed with a coupling recess downwardly extending from the top of the inclined surface. Herein, the coupling recess of the first coupling part and the coupling protrusion of the first corresponding coupling part may be identical within a numerical tolerance of machining so that the coupling recess of the first coupling part and the coupling protrusion of the first corresponding coupling part may be coupled in a female and male type. However, vertical lengths of the coupling recess and the coupling protrusion may not be identical.

The first coupling part 150 that mainly performs a rotation prevention function may be formed with, for example, four circular coupling recesses 152 associated with respective first corresponding coupling parts 130 formed with four circular coupling protrusions 132 as shown in a sectional planar view of FIG. 3b.

Hereinafter, with reference to the figures, a structure in which the first corresponding coupling part 130 is formed with a circular coupling protrusion 132, and a first coupling part 150 is formed with a circular coupling recess 152 coupled in association with the circular coupling protrusion 132 of the first corresponding coupling part 130 will be described in detail. Persons skilled in the art may easily know that an identical coupling and separating process may be applied to a structure in which the first corresponding coupling part 130 is formed with a circular coupling recess (not shown), and the first coupling part 150 is formed with a circular coupling protrusion (not shown) that is coupled in association with the circular coupling recess. The present invention should be construed to include both structures.

In addition, the present invention may additionally include a second corresponding coupling part 160 that is protruded radially outwardly from the abutment 120 and formed in a lower part or an upper part of the first corresponding coupling part 130, and mainly performs a vertical separation prevention function. Preferably, the second corresponding coupling part 160 may be provided on a location of the coupling leg, below the first corresponding coupling part 130.

In addition, in the present invention, the first coupling part and the first corresponding coupling part may additionally perform functions of a second coupling part and the second corresponding coupling part.

In the second corresponding coupling part 160 that mainly performs a vertical separation prevention function, as shown in FIG. 2, an upper sectional surface of a coupling protrusion protruding radially outwardly from the abutment 120 forms a coupling planar surface 162 of the second corresponding coupling part, and a longitudinal sectional surface of the second corresponding coupling part that mainly performs a vertical separate prevention function by the coupling protrusion may be formed with a sectional surface in which a radius thereof is downwardly reduced.

In addition, in the inner surface of the axial hole of the fixture, a second coupling part 170 that is formed with a stepped portion in a concave shape formed extending outward, and which is coupled in association with the second corresponding coupling part 160 may be further included.

The second coupling part 170 may be an annular stepped portion provided in a predetermined vertical position on the inner surface of the axial hole of the fixture to extend along the entire circumference. Alternatively, the second coupling part 170 may be a concave-convex portion like the first coupling part, more particularly, a coupling recess depressed outward in a predetermined location, instead of being provided as an annular stepped portion extending along the entire circumference.

In addition, the first coupling part and the second coupling part may be integrated and configured in a single coupling part.

The second coupling part 170 formed with the stepped portion as described above has a structure that includes a coupling planar surface 172 of the second coupling part which is associated with the coupling planar surface 162 of the second corresponding coupling part 160 that mainly performs a vertical separation prevention function. In addition, an angle formed where the coupling planar surface of the second coupling part and the coupling planar surface of the second corresponding coupling part meet a vertical central axis 1 may vary.

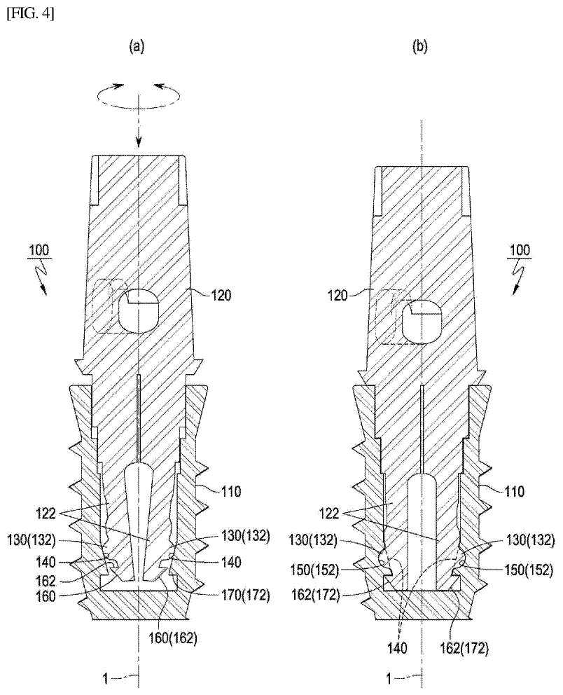

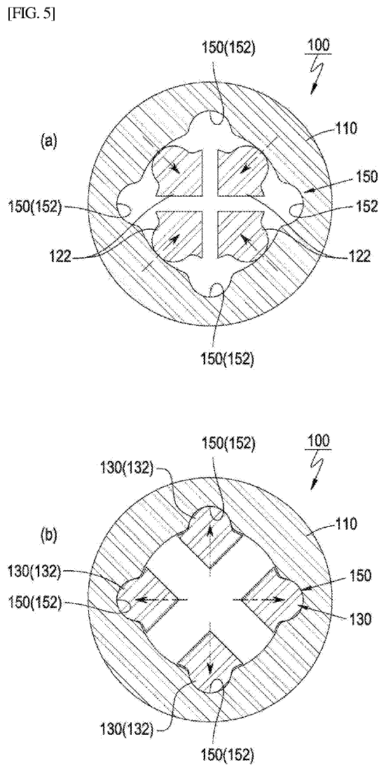

The second corresponding coupling part 160 and the second coupling part 170 as descried above, as shown in FIG. 4a, become automatically separated from each other since the coupling leg 122 is elastically bent radially inwardly when the first corresponding coupling part 130 is detached and separated from the first coupling part 150.

However, when the first corresponding coupling part 130 and the first coupling part 150 are coupled, as shown in FIG. 4b, the second corresponding coupling part 160 and the second coupling part 170 are simultaneously coupled so that axial directional coupling force between the abutment 120 and the fixture 110 is reinforced. Accordingly, the second corresponding coupling part and the second coupling part which mainly perform a vertical separation prevention function may maintain vertical separation prevention coupling force without any damage during repeated detachments.

In addition, the first corresponding coupling part 130 formed with the coupling protrusion 132 is formed on an associated inclined surface 180 formed in a lower outer surface of each coupling leg 122, and coupled in association with the coupling recess 152 of the first coupling part 150.

The outer surface of the coupling leg 122 in which the first corresponding coupling part 130 is formed may be formed to have a slope identical to a slope of the inner surface 140 of the axial hole of the fixture 110 in which the first coupling part 150 is formed.

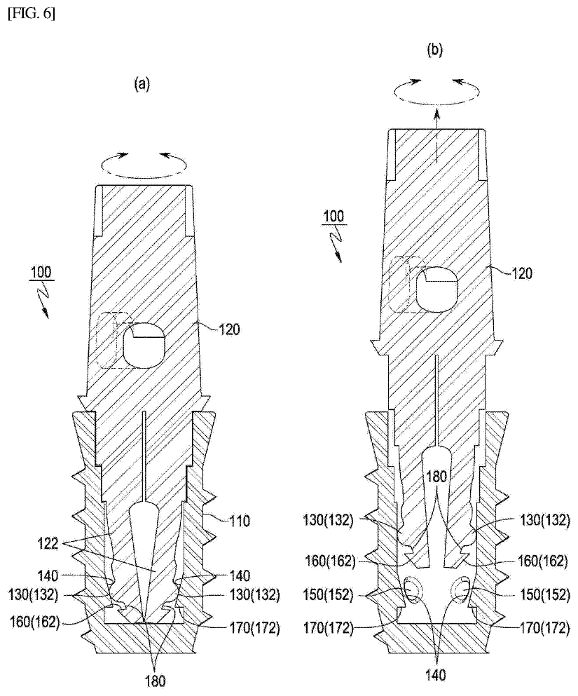

In the dental implant 100 of the present invention configured as above, the abutment 120 is completely pushed into an axial hole 112 of the fixture 110 as shown in FIG. 4a and FIG. 5a, and the abutment 120 is rotated in a circumferential direction in order to couple the abutment 120 with the fixture 110.

Accordingly, the circular coupling protrusion 132 of the first corresponding coupling part 130 formed in each coupling leg 122 of the abutment 120 is coupled in association with the circular coupling recess 152 of the first coupling part 150 formed on the inner surface 140 of the axial hole of the fixture 110 as shown in FIG. 4b and FIG. 5b.

Alternatively, in order to separate the abutment 120 from the fixture 110 while the abutment 120 and the fixture 110 are coupled, the abutment 120 is rotated in a circumferential direction within the fixture 110.

The above state is shown in FIG. 6a. In other words, in the dental implant 100 of the present invention, the first corresponding coupling part 130 comes out and is separated from the first coupling part 150 by rotating the abutment 120 in a circumferential direction with respect to the fixture 110 while the abutment 120 is coupled within the fixture 110. At the same time, the second corresponding coupling part 160 that mainly performs a vertical separation prevention function automatically comes out from the second coupling part 170.

Accordingly, when the first corresponding coupling part 130 that mainly performs a rotation prevention function of the abutment in a circumferential direction with respect to the abutment is rotated in a circumferential direction and separated from the first coupling part 150 by rotation force equal to or greater than a predetermined value, and the second corresponding coupling part 160 that mainly performs a vertical separation prevention function is come out from the second coupling part 170. In this state, the abutment can be easily separated from the fixture by being pulled upwardly. More preferably, the first coupling part 150 comprises at least one first coupling part provided in a circumferential direction of the inner surface of the axial hole of the fixture so as not to provide an annular shape along the entire circumference, such that the abutment is coupled to the fixture at a predetermined angle when the abutment is pushed into the fixture and the first corresponding coupling part 130 of the abutment is releasable from the first coupling part 150 when the abutment is rotated in the circumferential direction by a predetermined level of torque or higher applied thereto

More preferably, the inclined surface 140 may be provided on the inner surface of the axial hole 112 except for a region of the inner surface in which the first coupling part 150 is provided, such that the diameter of the inclined surface 140 continuously decreases in a bottom direction of the axial hole 112. In this case, in the process of separating the abutment 120 from the fixture 110, when the abutment 120 is rotated with respect to the fixture 110, the first corresponding coupling part 130 pushes the abutment 120 upwards from the fixture 110 due to elastic repulsion from the inclined surface 140 while being released from the first coupling part 150, so that the abutment 120 and the fixture 110 can be more easily separated.

Accordingly, in the present invention, the abutment 120 may be separated from the fixture 11 with less force, whereby a large pulling force may not be applied to an alveolar bone of a patient as in the past. In addition, a decrease in vertical separation prevention coupling force of the abutment with respect to the fixture does not occur when the abutment is repeatedly attached to and detached from the fixture.

As described above, according to the present invention, it is possible to minimize the risk of injury to the patient during the implant procedure, and an operator may easily determine a separation state between the abutment 120 and the fixture 110 since the abutment 120 can be separated from the fixture only by rotating the abutment 120 with respect to the fixture 110. Accordingly, an implant operator may easily and conveniently progress the procedure without difficulty and worry.

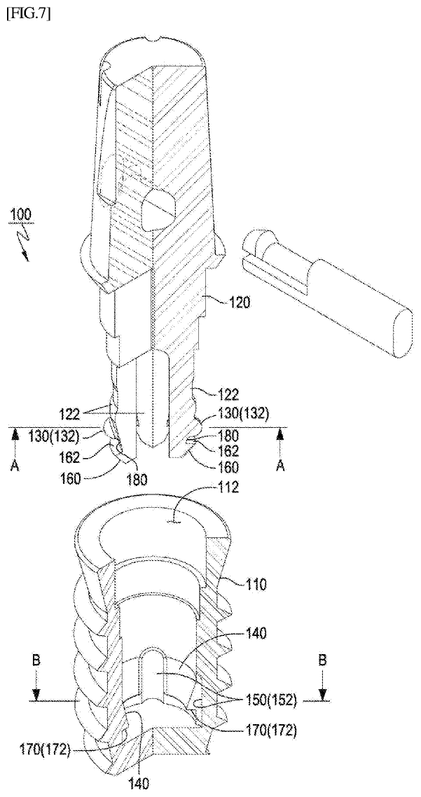

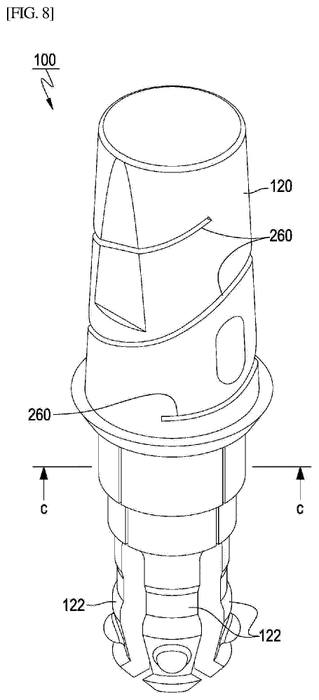

As illustrated in FIG. 7, the first coupling part 150 may be provided with the coupling recess 152 extending downward from the top end in the inner surface of the axial hole 112 of the fixture 110, so that the coupling position of the fixture and the abutment can be more easily determined during a procedure. Specifically, the axial hole 112 of the fixture 110 is configured such that the diameter of the inner surface thereof above the first coupling part 150 is not smaller than the outer diameter of the first corresponding coupling part 130, so that the first corresponding coupling part 130 can enter the first coupling part 150 without significant resistance. Furthermore, since the first coupling part 150 guides the coupling protrusion 132 of the first corresponding coupling part 130 of the abutment 120 that is fitted into the axial hole 112 of the fixture 110, the medical practitioner can easily determine the coupling angle and position of the fixture 110 and the abutment 120 by aligning the coupling protrusion 132 of the abutment 120 with the first coupling recess 152 of the fixture and then pushing the abutment 120 into the axial hole 112.

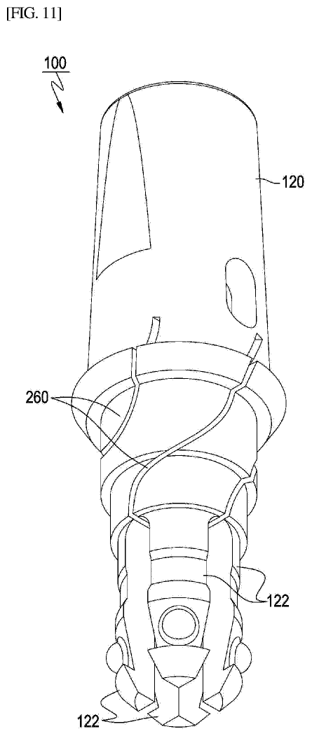

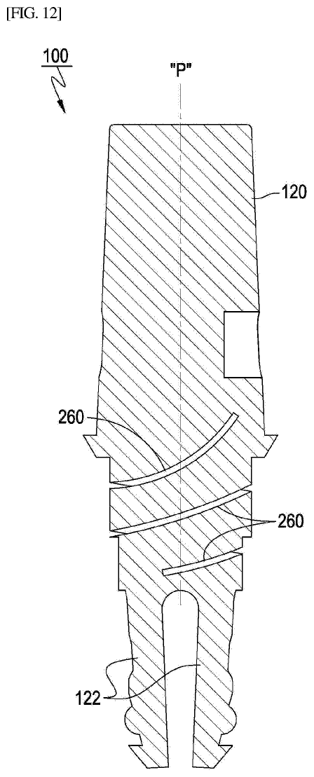

As illustrated in FIG. 8 and FIG. 11, a slit may be further provided between the top portion of the abutment 120 and the first coupling part 150 to linearly or spirally extend in a top-bottom direction of the abutment 120 while dividing the cross-section into a plurality of segments. More preferably, as illustrated in FIG. 8, a spiral slit 260 may be formed on the upper part of the abutment 120. In addition, as illustrated in FIG. 11, a spiral slit 260 may be formed in the middle of the abutment 120

The spiral slit 260, including the top point to the bottom point, extends through the abutment 120 in a transverse direction to divide the horizontal cross-section of the abutment 120 into a plurality of segments. When viewed from the outer side surface of the abutment 120, the spiral slit 260 has a spiral shape continuously extending in the top-bottom direction of the abutment 120.

According to this structure, when external force is applied to the abutment 120, the spiral slit 260 can provide absorbing ability to the abutment 120 to reduce impacts applied to the fixture 110 coupled to the alveolar bone. In addition, when a patient having the implant chews food, the patient can sense a minute pressure absorbing action. Accordingly, the sensation of chewing of the patient can be significantly improved.

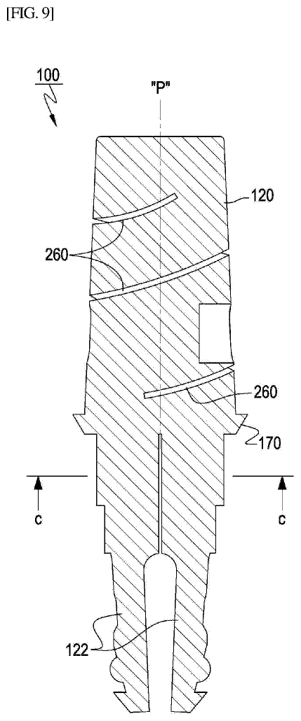

Preferably, in the dental implant according to the present invention, the outer diameter of the abutment 120 along C-C line of FIG. 8 and FIG. 9 is greater than the inner diameter of the top portion of the axial hole of the fixture.

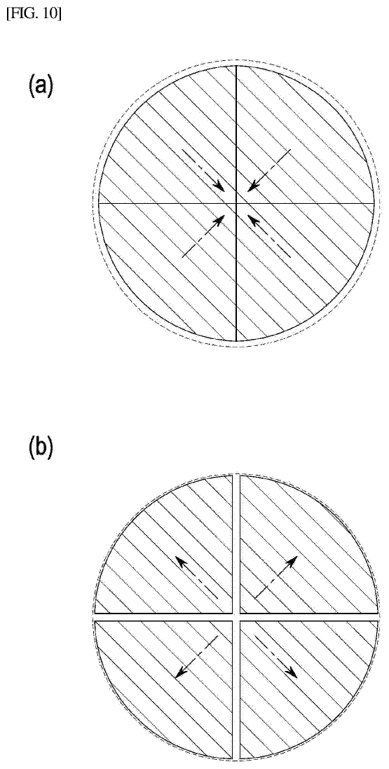

As shown in FIG. 10a, the outer diameter of the abutment coupled to the top portion of the axial hole of the fixture is greater than the inner diameter of the top portion of the axial hole of the fixture before the abutment and the fixture are coupled, when the abutment is fitted into the fixture, the abutment is radially contracted toward the central axis thereof by the slit provided therein. Consequently, the outer diameter of the contracted abutment corresponds to the inner diameter of the top portion of the axial hole of the fixture, so that the abutment can be firmly coupled to the axial hole of the fixture.

Furthermore, as shown in FIG. 10b, after coupling, the abutment presses against the inner surface of the axial hole of the fixture outwards while being elastically restored from the contracted position, thereby supporting the fixture. In this manner, the abutment and the fixture can be more firmly coupled. The above-described structure can significantly improve sealing performance in joining portions of the abutment and the fixture, thereby minimizing microscopic apertures or gaps in the joining portions. This can fundamentally overcome the problem of external bacteria or germs penetrating into the fixture. Although embodiments have been described with reference to a number of illustrative embodiments thereof, it is to be understood that the invention is not limited to this specific structure. Rather, modifications and changes will be apparent to a person having ordinary skill in the art without departing from the principle of the invention defined in the following claims. For example, strong rotation force may be applied to the fixture by forming a polygonal form in the inner surface of the axial hole of the fixture or a lower part thereof when implanting the fixture in the alveolar bone. For example, a single coupling part in which functions of the first coupling part and the second coupling part are integrated may be formed. Herein, the structure, that is configured to enable easy separation of the abutment from the fixture by contacting the corresponding coupling part formed in the lower part of the abutment with the axial hole inner inclined surface formed in the axial hole inner surface of the fixture, and by upwardly pushing the abutment by elastic repulsion when the abutment is rotated while the abutment is coupled with the fixture is not changed. In addition, forms of the first coupling part and the first corresponding coupling part that mainly performs a rotation prevention function and the first corresponding coupling part may be not associated 100%. In other words, although the forms of the first coupling part first corresponding coupling part do not complementarily associate 100%, it is only necessary to be able to perform a rotation prevention function for rotation force equal to or less than a predetermined value. As another example, both of the first and second corresponding coupling parts may not be formed in the coupling leg. In other words, the first and second corresponding coupling parts may be formed in a part of the coupling legs. As another example, the first coupling part or the first corresponding coupling part which are circular may have various forms other than a circular form. In addition, four coupling legs 122 are formed in the example of the figure. However, one to six or more coupling legs 122 may be formed, and the first corresponding coupling part 130 may be formed in each coupling leg 122. In association with this, the first coupling part 150 may be formed. In addition, the second coupling part may have various coupling angles and forms depending on the vertical central axis. In other words, the planar surface of the second corresponding coupling part may be formed to have a gradual angle rather than the planar surface. In addition, as another example, the inclined surface in which the first coupling part is formed may be formed in a stepped form rather than a continuous surface. Meanwhile, whichever coupling method in which the abutment is coupled with the fixture, as the method in which the coupling protrusion and the coupling recess are elastically coupled with each other by elastic repulsion thereof, it should be construed that the structure, in which the abutment and the fixture are easily separated by upwardly pushing the abutment from the fixture by elastic repulsion between the coupling protrusion of the corresponding coupling part formed in the lower part of the abutment and the inclined surface formed in the axial hole inner surface of the fixture when the abutment is rotated while the abutment is coupled with the fixture, is included in the scope of the present invention. In other words, it should be construed that all cases in which the first coupling part formed with the coupling recess in the inclined surface of the axial hole inner surface of the fixture and which is elastically coupled with the abutment is included, and the abutment and the fixture are easily separated from each other, by upwardly pushing the abutment from the fixture by elastic interaction between the inclined surface of the axial hole inner surface of the fixture and the first corresponding coupling part formed in the lower part of the abutment when the abutment is rotated with respect to the fixture while the abutment and the fixture are coupled with each other since the first corresponding coupling part is formed in the abutment in association with the first coupling part are included in the scope of the present invention. In addition, a simple design modification including technical characteristic of the present invention may be included within the spirit and scope of the present invention.

1. A dental implant comprising:
a fixture 110 implanted in an alveolar bone to provide an artificial tooth root;
an abutment 120 coupled with a prosthesis at an upper part thereof, and provided at a lower part thereof with a coupling leg 122 elastically coupled with an axial hole 112 of the fixture by being elastically bent radially inwardly toward a central axis 1 and restoring an original shape thereof;
a first coupling part 150 provided on an inner surface of the axial hole of the fixture, the first coupling part comprising a coupling recess 152 depressed outward, in a predetermined location on the inner surface of the axial hole; and
a first corresponding coupling part 130 provided on an outer surface of the coupling leg 122 to be complementarily coupled to the first coupling part 150, the first corresponding coupling part comprising a coupling protrusion 132,
wherein the first coupling part is provided on the inner surface of the axial hole so as not to provide an annular shape along an entire circumference, such that the abutment is coupled to the fixture at a predetermined angle when the abutment is pushed into the fixture; and
wherein, in a state in which the abutment is fitted into the fixture by complementary coupling between the first coupling part and the first corresponding coupling part, when a rotation force applied to the abutment has less than a predetermined level, the abutment is prevented from rotating relative to the fixture in a circumferential direction, and when the rotation force applied to the abutment is equal to or greater than the predetermined level, the coupling leg of the abutment is elastically bendable radially inwardly toward a central axis and the abutment is rotated in the circumferential direction, allowing the coupling protrusion of the first corresponding coupling part to be released from the coupling recess of the first coupling part, so that the fixture and the abutment are decoupled from each other.

2. The dental implant according to claim 1, wherein an inclined surface is provided on the inner surface of the axial hole of the fixture except for a region of the inner surface in which the first coupling part is provided, such that an inner diameter of the inclined surface continuously decreases in a bottom direction, and when the coupling protrusion of the first corresponding coupling part is released from the coupling recess of the first coupling part by rotation of the abutment in the circumferential direction, the coupling protrusion of the first corresponding coupling part pushes the abutment upwards from the fixture due to elastic repulsion from the inclined surface of the inner surface of the axial hole of the fixture, thereby automatically decoupling the abutment and the fixture from each other.

3. The dental implant according to claim 1, wherein a slit is provided between a top portion of the abutment and the first coupling part to linearly or spirally extend in a top-bottom direction of the abutment while dividing a cross-section of the abutment into a plurality of segments.

4. The dental implant according to claim 1, an outer diameter of the abutment coupled to a top portion of the axial hole of the fixture is greater than an inner diameter of the top portion of the axial hole of the fixture before the abutment and the fixture are coupled, when the abutment is fitted into the fixture, the coupling leg of the abutment is radially contracted toward the central axis thereof and consequently the outer diameter of the abutment corresponds to the inner diameter of the top portion of the axial hole of the fixture, so that the abutment can be firmly coupled to the axial hole of the fixture.

5. A dental implant comprising:
a fixture 110 implanted in an alveolar bone to provide an artificial tooth root;
an abutment 120 coupled with a prosthesis at an upper part thereof, and provided at a lower part thereof with a coupling leg 122 elastically coupled with an axial hole 112 of the fixture by being elastically bent radially inwardly toward a central axis 1 and restoring an original shape thereof;
a first coupling part 150 provided on an inner surface of the axial hole of the fixture, the first coupling part comprising a coupling recess 152 depressed outward, in a predetermined location on the inner surface of the axial hole; and
a first corresponding coupling part 130 provided on an outer surface of the coupling leg 122 to be complementarily coupled to the first coupling part 150, the first corresponding coupling part comprising a coupling protrusion 132,
wherein the first coupling part is provided on the inner surface of the axial hole of the fixture so as not to provide an annular shape along an entire circumference, such that the abutment is coupled to the fixture at a predetermined angle when the abutment is pushed into the fixture, and the first corresponding coupling part of the abutment is releasable from the first coupling part when the rotation force applied to the abutment is equal to or greater than a predetermined level and then the abutment is rotated in the circumferential direction,
wherein a second corresponding coupling part 160 is provided on an outer circumferential surface of the coupling leg provided on the lower part of the abutment, the second corresponding coupling part comprising a fitting protrusion 162 protruding from the outer circumferential surface of the coupling leg to prevent the abutment from being vertically decoupled from the fixture, and a second coupling part 170 is provided on the inner surface of the axial hole of the fixture, the second coupling part comprising a stepped portion 172 extending outward to be coupled to the second corresponding coupling part in a corresponding manner, and
wherein, when the first coupling part and the first corresponding coupling part are coupled to each other, the second corresponding coupling part and the second coupling part are coupled to each other to enhance axial coupling force between the abutment and the fixture, and when the first corresponding coupling part is released from the first coupling part by rotation of the abutment in the circumferential direction, the second corresponding coupling part is automatically released from the second coupling part as the coupling leg of the abutment is elastically bent inwardly, so that the fixture and the abutment are decoupled from each other.

6. The dental implant according to claim 5, wherein an inclined surface is provided on the inner surface of the axial hole of the fixture except for a region of the inner surface in which the first coupling part is provided, such that an inner diameter of the inclined surface continuously decreases in a bottom direction, and when the coupling protrusion of the first corresponding coupling part is released from the coupling recess of the first coupling part by rotation of the abutment in the circumferential direction, the coupling protrusion of the first corresponding coupling part pushes the abutment upwards from the fixture due to elastic repulsion from the inclined surface of the inner surface of the axial hole of the fixture, thereby automatically decoupling the abutment and the fixture from each other.

7. The dental implant according to claim 5, wherein the second coupling part comprises an annular stepped portion to extend along an entire circumference or a coupling recess depressed outward in a predetermined location, in a predetermined vertical position on the inner surface of the axial hole of the fixture.

8. The dental implant according to claim 5, an outer diameter of the abutment coupled to a top portion of the axial hole of the fixture is greater than an inner diameter of the top portion of the axial hole of the fixture before the abutment and the fixture are coupled, when the abutment is fitted into the fixture, the coupling leg of the abutment is radially contracted toward the central axis thereof and consequently the outer diameter of the abutment corresponds to the inner diameter of the top portion of the axial hole of the fixture, so that the abutment can be firmly coupled to the axial hole of the fixture.

9. The dental implant according to claim 5, wherein the axial hole of the fixture is configured such that a diameter of the inner surface thereof above the first coupling part is larger than an outer diameter of the first corresponding coupling part, so that the first corresponding coupling part enters the first coupling part without significant resistance, thereby allowing a coupling angle and position of the fixture and the abutment to be easily determined.

10. The dental implant according to claim 5, wherein a slit is provided between a top portion of the abutment and the first coupling part to linearly or spirally extend in a top-bottom direction of the abutment while dividing a cross-section of the abutment into a plurality of segments.
